(19) United States
(12) Patent Application Publication
(10) Pub. No.: US 2016/0269428 A1
(43) Pub. Date: Sep. 15, 2016

(54) DATA PROCESSING

(71) Applicant: Hangzhou H3C Technologies Co., Ltd., Hangzhou City (CN)

(72) Inventors: Xinzhe WEI, Beijing (CN); Zequan REN, Beijing (CN); Xiaojun SUN, Beijing (CN)

(73) Assignee: Hangzhou H3C Technologies Co., Ltd., Hangzhou City (CN)

(21) Appl. No.: 15/031,630

(22) PCT Filed: Oct. 31, 2014
(86) PCT No.: PCT/CN2014/089986

§ 371 Date: Apr. 22, 2016

(30) Foreign Application Priority Data
Nov. 1, 2013 (CN) 201310535210.6

(51) Int. Cl. H04L 29/06; G06F 17/30; H04L 29/08

(52) U.S. Cl. CPC H04L 63/1416; H04L 67/10; G06F 17/30348; G06F 17/30424

(57) ABSTRACT

A service logic layer module receives an application message forwarded by a network device, classifies and identifies an application type of the application message, and determines a first processing operation to be performed to the application message based on an identification result. The service logic layer module receives a processing result returned from a data processing layer module, and determines a second processing operation based on the processing result. When the processing operation is an I/O processing operation for a single task, the data processing layer module controls I/O concurrency processing of the single task and returns a final processing result to the service logic layer module. When the processing operation is a data searching operation, the data processing layer module performs the data searching operation to obtain a final searching result, and returns the final searching result to the service logic layer module.

### BACKGROUND

With explosive increasing of network data, during service processing procedures of most network devices, deficiencies in network resources may occur due to the increasing of the network data, such as deficiencies in central processing unit (CPU) resources, deficiencies in storage resources, etc., which may lead to a slow processing speed of the network device or even lead to a failure of the network device.

### BRIEF DESCRIPTION OF THE DRAWINGS

Features of the present disclosure are illustrated by way of example and not limited in the following figure(s), in which like numerals indicate like elements, in which:

FIG. 1A is a diagram illustrating a structure of a data processing system, according to various examples of the present disclosure.

FIG. 1B is a diagram illustrating a structure of a data processing system, according to various examples of the present disclosure.

FIG. 2 is a diagram illustrating a hardware topology for running the data processing system, according to various examples of the present disclosure.

FIG. 3A is a flowchart illustrating a running process of the data processing system, according to various examples of the present disclosure.

FIG. 3B is a flowchart illustrating a running process of the data processing system, according to various examples of the present disclosure.

FIG. 4 is a diagram illustrating a structure of a concurrency processing sub-module, according to various examples of the present disclosure.

FIG. 5 is a diagram illustrating a structure of a searching sub-module, according to various examples of the present disclosure.

FIG. 6 is a flowchart illustrating an implementation process of the searching sub-module, according to various examples of the present disclosure.

FIG. 7 is a diagram illustrating a structure for implementing intrusion defense through a network device in conjunction with the data processing system, according to various examples of the present disclosure.

### DETAILED DESCRIPTION

Hereinafter, the present disclosure will be described in further detail with reference to the accompanying drawings and examples.

In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, and the term “including” means including but not limited to. The term “based on” means based at least in part on. In addition, the terms “a” and “an” are intended to denote at least one of a particular element.

According to various examples of the present disclosure, the deficiencies in the network resources may be described taking a network device applied to an intrusion defense system as an example.

Usually, the intrusion defense system is deployed in an inline working mode. In a data transmission path, a message is detected by a network device thereof. Once the network device detects an attack action such as worms, viruses, backdoors, Trojan Horse, spyware, suspicious codes, phishing, etc., the network device may immediately interrupt the attack, isolate an attack source, shield the worms, viruses and spyware, record a log and inform a network administrator, so that the viruses may be prevented from spreading in the network.

However, during the conventional processing on a message performed by the intrusion defense system, two processing operations including application identification (Universal Application Apperceiving Engine, UAAE) and depth detection (Open CIF, OCIF) may occupy a large number of CPU resources of the network device. The UAAE technology refers to the technology that may accurately identify an application protocol and an application using a unified application protocol and application definition language technology, application protocol model classification and identification technology, and intelligent decision-making technology of the application protocol. An OCIF management framework may adopt a Dynamic Link Library design, which may be good for dynamic loading of the Web and engines when they are used and avoid process maintenance and resource occupation in a Daemon mode. Through test data it may be found that UAAE and OCIF almost occupy all of CPU resources of the network device when they are running. In the case where there is a great deal of data calculated in the current intrusion defense system, deficiencies in the CPU resources may occur in the network device, requirements of the intrusion defense are not met, and the network device may be encumbered to perform other processing operations.

In view of the above, various examples of the present disclosure describe a data processing system, which may be run on a physical host constructed by a plurality of virtual machines or on a cluster device constructed by a set of physical hosts.

Hereinafter, the data processing system is described in further detail.

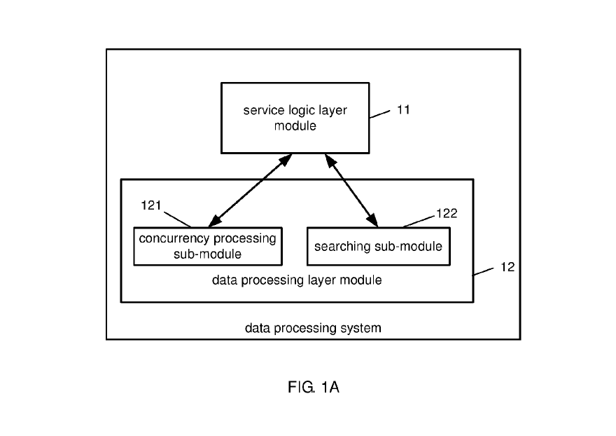

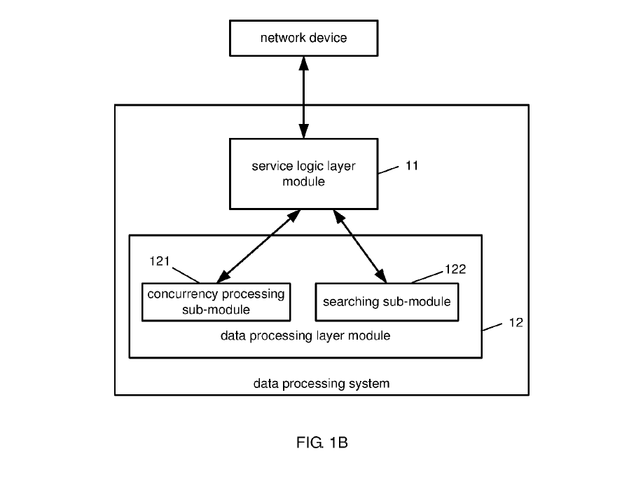

FIG. 1A is a diagram illustrating a structure of the data processing system, according to various examples of the present disclosure. As shown in FIG. 1A, the data processing system may include a service logic layer module 11 and a data processing layer module 12, which are described as follows.

The service logic layer module 11 may receive an application message forwarded by a network device, classify and identify an application type of the application message, and determine a first processing operation to be performed to the application message based on an identification result. The service logic layer module 11 may receive a processing result returned from the data processing layer module 12, and determine a second processing operation based on the processing result.

The data processing layer module 12 may include a concurrency processing sub-module 121 and a searching sub-module 122.

When the processing operation determined by the service logic layer module 11 is an I/O processing operation for a single task, the concurrency processing sub-module 121 may control I/O concurrency processing of the single task and return a final processing result to the service logic layer module 11 after the I/O concurrency processing of the single task is performed.

When the processing operation determined by the service logic layer module 11 is a data searching operation, the searching sub-module 122 may perform the data searching operation to obtain a final searching result, and return the final searching result to the service logic layer module 11.

Hereinafter, the service logic layer module 11 and the data processing layer module 12 as shown in FIG. 1A are described with reference to FIG. 1B.

According to various examples of the present disclosure, the service logic layer module 11 may store preconfigured service logic such as a preconfigured feature state machine which has a state and is used to trace a data feature of an application message, and an application protocol model established for at least one application protocol in advance, in which the application protocol model may facilitate the service logic layer module 11 to perform application identification to an application message subsequently received.

According to various examples of the present disclosure, the service logic stored in the service logic layer module 11 may include logic commonly used in a variety of security products, which may not be repeated herein.

According to various examples of the present disclosure, the service logic layer module 11 may receive an application message forwarded by a network device, in which the application message may be supposed to be processed by the network device. When receiving the application message, the service logic layer module 11 may classify and identify an application type of the application message using the preconfigured application protocol model, and/or, the service logic layer module 11 may identify a data feature of the application message and trace the data feature of the application message through the preconfigured feature state machine so as to accurately identify the application type of the application message.

The service logic layer module 11 may determine a processing operation to be performed to the application message according to an identification result and notify the data processing layer module 12 to perform the processing operation determined by the service logic layer module 11. The service logic layer module 11 may analyze, considering a current application environment, a result returned from the data processing layer module 12 after the processing operation is performed by the data processing layer module 12, and determine a corresponding processing operation based on an analysis result. When the processing operation is to be performed by the data processing layer module 12, the service logic layer module 11 may notify the data processing layer module 12 to perform the processing operation. When the processing operation is to be performed by the network device, e.g., the processing operation is policy management of which the CPU resources occupied when the policy management is performed is relatively little, the service logic layer module 11 may notify the network device to perform the processing operation. In this way, the data processing accuracy can be improved.

According to various examples of the present disclosure, the application message forwarded by the network device and received by the service logic layer module 11 may be forwarded by the network device when the network device identifies, according to a requirement of the application message, that processing of the application message meets a defined condition.

According to various examples of the present disclosure, the defined condition may include but not be limited to a condition that the CPU resources of the network device occupied by the processing of the application message is greater than a defined threshold. Here, the threshold may be configured according to actual situations. For example, when the threshold is configured, it may be considered to send all of application messages that are supposed to be processed by the network device to the data processing system described in various examples of the present disclosure, or to send part of the application messages that are supposed to be processed by the network device to the data processing system described in various examples of the present disclosure, which is not limited herein.

According to various examples of the present disclosure, the service logic layer module 11 may be configured with a unified definition language and may provide an extensible and upgradable application identification and behavior identification ability to users. The definition language of the service logic layer module 11 combines a protocol definition, an attack feature definition, a content filtering feature definition, and an application protocol behavior definition, and may expand the above-mentioned “definition” functions.

An intrusion defense system may be taken as an example. In the example, the CPU resources of the network device occupied by the UAAE when the UAAE is performed is greater than the defined threshold described above. In this case, when the network device receives the application message, the network device may identify that the application message is used for intrusion defense. The network device may perform some processing operations to the application message where the CPU resources occupied by these processing operations is far less than the defined threshold. The network device may send the processed application message to the service logic layer module 11. The service logic layer module 11 may receive the application message, analyze the application message to identify a feature behavior such as the attack from the message, perform protocol parsing to an application protocol of the application message, determine a corresponding processing operation is the UAAE, and notify the data processing layer module 12 to perform the UAAE. The service logic layer module 11 may analyze, considering a current application environment, a UAAE result returned from the data processing layer module 12 after the UAAE is performed by the data processing layer module 12 and determine a corresponding processing operation based on an analysis result. When the processing operation is to be performed by the data processing layer module 12, the service logic layer module 11 may notify the data processing layer module 12 to perform the processing operation. When the processing operation is to be performed by the network device, e.g., the processing operation is policy management of which the CPU resources occupied when the policy management is performed is relatively little, the service logic layer module 11 may notify the network device to perform the processing operation. In this way, the data processing accuracy can be improved.

The data processing layer module 12 may perform the processing operation determined by the service logic layer module 11. According to various examples of the present disclosure, the data processing layer module 12 may include a concurrency processing sub-module 121 and a searching sub-module 122.

When the processing operation determined by the service logic layer module 11 is an I/O processing operation for a single task, the concurrency processing sub-module 121 may control the I/O concurrency processing of the single task and return a final processing result to the service logic layer module 11 after the I/O concurrency processing of the single task is performed.

When the processing operation determined by the service logic layer module 11 is a data searching operation, the searching sub-module 122 may perform the data searching operation to obtain a final searching result, and return the final searching result to the service logic layer module 11.

So far, descriptions of the system as shown in FIG. 1B are completed.

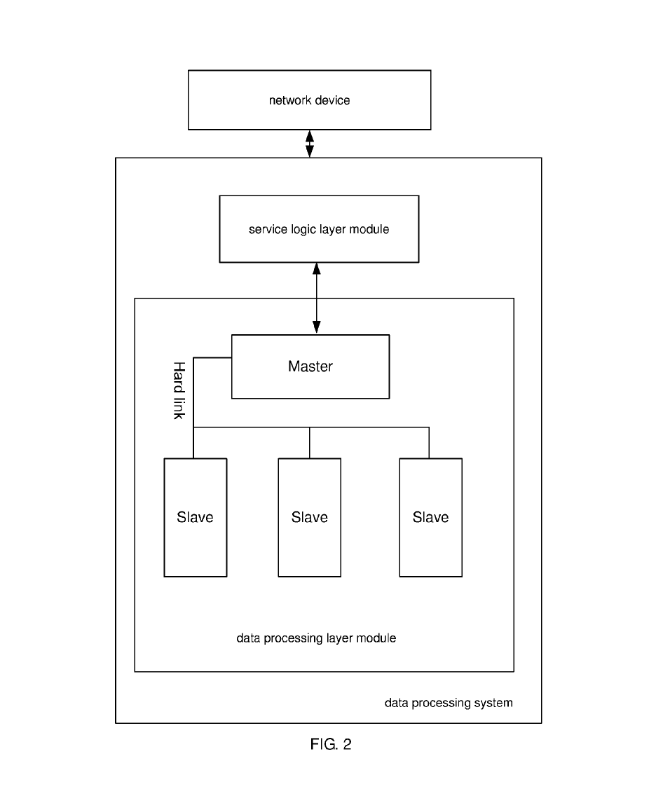

Corresponding to the system shown in FIGS. 1A and 1B, various examples of the present disclosure describe a hardware structure running the data processing system. FIG. 2 is a diagram illustrating a hardware topology for running the data processing system, i.e., a server hardware network topology for running the data processing system, according to various examples of the present disclosure.

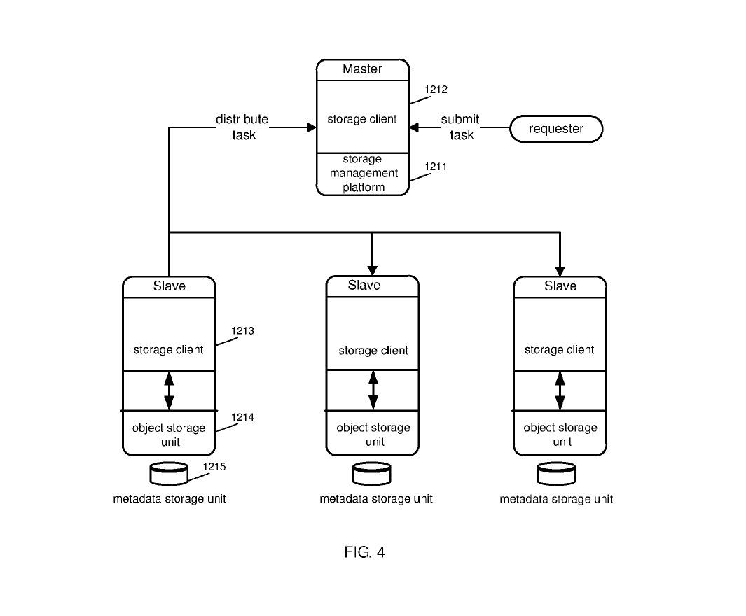

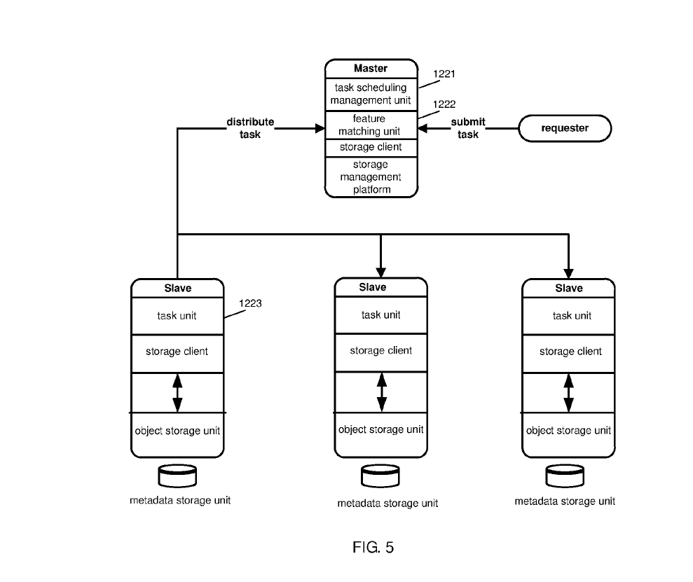

According to various examples of the present disclosure, the data processing layer module in the data processing system may be constructed by a plurality of system nodes including a master node (may be denoted as Master in the figure) and at least one data node (may be denoted as Slave in the figure). In this case, the master node and the data node are all hardware modules such as hardware servers. The concurrency processing sub-module and the searching sub-module of the data processing layer module are deployed on the master node and the at least one data mode as shown in FIG. 2. The concurrency processing sub-module and the searching sub-module are not shown in FIG. 2 and are described later with reference to FIGS. 4 and 5.

According to an example of the present disclosure, the service logic layer module of the data processing system may be integrated in the master node. According to another example of the present disclosure, the service logic layer module of the data processing system may be implemented by a single virtual machine which is configured as an upstream device of the master node. FIG. 2 illustrates a situation where the service logic layer module is configured as the upstream device of the master node.

According to an example of the present disclosure, the master node and a data node are connected through a hard link, and data nodes are connected through the hard link.

In this case, connecting the master node and the data node through the hard link may be implemented as follows: the master node and the data node directly communicate with each other without forwarding of a third party device. Connecting the data nodes through the hard link may be implemented as follows: the data nodes directly communicate with each other without forwarding of the third party device.

According to various examples of the present disclosure, Hypertext Transfer Protocol (HTTP) transmission is replaced with the hard link between the master node and the data node as well as the hard link between the data nodes. In this way, the I/O concurrency processing of the single task can be ensured, the network storm can be effectively reduced, the network traffic can be distributed, and the possibility of a network bottleneck can be reduced.

So far, descriptions of the hardware structure of the data processing system described in various examples of the present disclosure are completed.

Corresponding to the data processing system as shown in FIGS. 1A and 1B and the hardware topology running the data processing system as shown in FIG. 2, various examples of the present disclosure describe a running process of the data processing system.

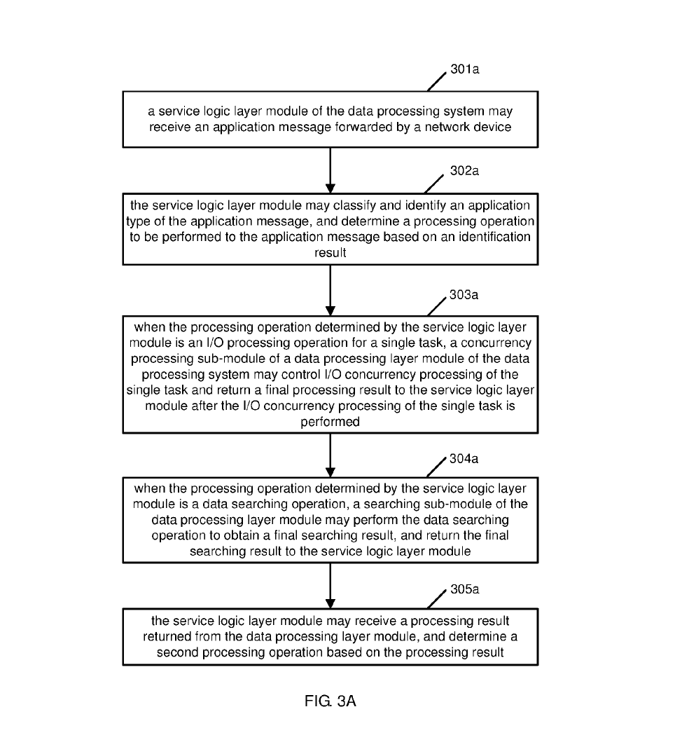

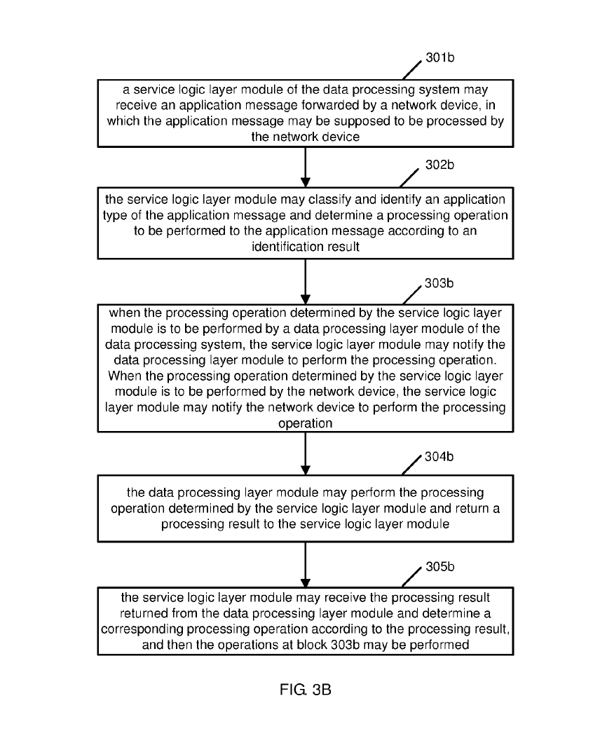

FIG. 3A is a flowchart illustrating the running process of the data processing system, according to various examples of the present disclosure. As shown in FIG. 3A, the process may include following operations.

At block 301a, a service logic layer module of the data processing system may receive an application message forwarded by a network device.

At block 302a, the service logic layer module may classify and identify an application type of the application message, and determine a processing operation to be performed to the application message based on an identification result.

At block 303a, when the processing operation determined by the service logic layer module is an I/O processing operation for a single task, a concurrency processing sub-module of a data processing layer module of the data processing system may control I/O concurrency processing of the single task and return a final processing result to the service logic layer module after the I/O concurrency processing of the single task is performed.

At block 304a, when the processing operation determined by the service logic layer module is a data searching operation, a searching sub-module of the data processing layer module may perform the data searching operation to obtain a final searching result, and return the final searching result to the service logic layer module.

At block 305a, the service logic layer module may receive a processing result returned from the data processing layer module, and determine a second processing operation based on the processing result.

FIG. 3B is a flowchart illustrating the running process of the data processing system, according to various examples of the present disclosure. As shown in FIG. 3B, the process may include following operations.

At block 301b, a service logic layer module of the data processing system may receive an application message forwarded by a network device, in which the application message may be supposed to be processed by the network device.

In this case, the application message may be sent by the network device to the data processing system when the network device identifies, according to a requirement of the application message, that processing of the application message meets a defined condition.

According to various examples of the present disclosure, the defined condition may include but not be limited to a condition that the CPU resources of the network device occupied by the processing of the application message is greater than a defined threshold. Here, the threshold may be configured according to actual situations. For example, when the threshold is configured, it may be considered to send all of application messages that are supposed to be processed by the network device to the data processing system described in various examples of the present disclosure, or to send part of the application messages that are supposed to be processed by the network device to the data processing system described in various examples of the present disclosure, which is not limited herein.

At block 302b, the service logic layer module may classify and identify an application type of the application message and determine a processing operation to be performed to the application message according to an identification result.

In addition, when the service logic layer module classifies and identifies the application type of the application message at block 302b, the service logic layer module may classify and identify the application type of the application message using an application protocol model established for at least one application protocol in advance, and/or, the service logic layer module may identify a data feature of the application message and trace the data feature of the application message through a preconfigured feature state machine which has a state so as to accurately identify the application type of the application message.

At block 303b, when the processing operation determined by the service logic layer module is to be performed by a data processing layer module of the data processing system, the service logic layer module may notify the data processing layer module to perform the processing operation. When the processing operation determined by the service logic layer module is to be performed by the network device, the service logic layer module may notify the network device to perform the processing operation.

According to various examples of the present disclosure, when the service logic layer module determines that some processing operations are to be performed by the network device, the service logic layer module may notify the network device so that the network device may perform the processing operations in a conventional manner, which is not described in detail herein.

At block 304b, the data processing layer module may perform the processing operation determined by the service logic layer module and return a processing result to the service logic layer module. According to various examples of the present disclosure, when the processing operation determined by the service logic layer module is an I/O processing operation for a single task, a concurrency processing sub-module of the data processing layer module may control the I/O concurrency processing of the single task and return a final processing result to the service logic layer module after the I/O concurrency processing of the single task is performed. When the processing operation determined by the service logic layer module is a data searching operation, a searching sub-module of the data processing layer module may perform the data searching operation to obtain a final searching result, and return the final searching result to the service logic layer module.

At block 305b, the service logic layer module may receive the processing result returned from the data processing layer module and determine a corresponding processing operation according to the processing result, and then the operations at block 303b may be performed.

So far, descriptions of the process as shown in FIG. 3B are completed.

Based on the descriptions of FIGS. 1A to 3B, according to various examples of the present disclosure, the service logic layer module can model a wide variety of application protocols, identify classification of the application protocols, and perform intelligent decision-making based on the model identification, which can improve the data processing accuracy. In addition, the concurrency processing sub-module can realize concurrent execution of a single task, which can solve an issue where the single task cannot be concurrently executed. Further, the searching sub-module that costs many CPU resources is removed from the network device and is configured in the data processing system described in various examples of the present disclosure, and the searching operation is implemented in an isomerous manner. In this way, the I/O concurrency at a task level can be implemented and the deficiencies in the network resources of the network device can be avoided. In this case, the isomerous manner may refer to a manner in which the service logic layer module and the data processing layer module are separately deployed and perform asynchronous processing.

Hereinafter, the concurrency processing sub-module 121 and the searching sub-module 122 included in the data processing layer module 12 are described in further detail.

In this case, the data processing layer module 12 may for example be constructed by a master node and at least one data node. According to various examples of the present disclosure, the concurrency processing sub-module 121 may include a storage management platform 1211 and a storage client 1212 that are deployed in the master node, and a storage client 1213 and an object storage unit 1214 that are deployed in each data node. FIG. 4 illustrates a structure of the concurrency processing sub-module 121.

In the example, the storage management platform 1211 may manage the whole file system. The functions of the storage management platform 1211 are described as follows. The storage management platform 1211 may provide metadata of the whole file system to the storage client 1212 on the master node where the storage management platform 1211 is located, manage a naming space of the whole file system, maintain a directory structure and user rights of the whole file system, and maintain the consistency of the file system.

The storage client 1212 on the master node may interact with the storage management platform 1211 to manage the directory and the naming space, and determine an object corresponding to data to be performed with the single task I/O concurrency processing.

The storage client 1213 on the data node may provide access to the file system and interact file data with the object storage unit 1214 to implement the I/O concurrency processing, including the reading and writing of the file data, changing of an object attribute, etc.

The object storage unit 1214 on the data node has intelligence and flexibility as well as has a CPU, a memory, a network and a disk system thereof. The functions of the object storage unit 1214 may include data storage, intelligence and flexibility distribution, and management of object metadata.

According to an example of the present disclosure, the object storage unit 1214 may store data taking an object as a basic unit. In this case, an object may maintain attributes of the object and have a unique identification. The object may at least include a combination of a set of attributes of the file data. Among them, a set of the attributes of the file data may be defined based on a RAID parameter, data distribution, and service quality of a file. Taking an intrusion defense application as an example, an object stored in the object storage unit 1214 may include an attribute corresponding to a vulnerability feature library, a virus feature library, or a protocol feature library.

According to various examples of the present disclosure, the object storage unit 1214 stores data taking the object as the unit, which can simplify a storage management task and increase the flexibility. Here, the size of the object may be different. The object may include the whole data structure, such as a file, a database entry, etc.

According to various examples of the present disclosure, the object storage system may use the object to manage the metadata included in the object. The object storage system may store the data in a metadata storage unit 1215 associated with the object storage unit 1214, such as a disk, and provide access of the data to the external through the object. Storing the metadata of the object in the metadata storage unit 1215 associated with the object storage unit 1214 can reduce the burden of the file system management module and improve the concurrency access performance and extensibility of the whole file system.

Based on the concurrency processing sub-module 121 as shown in FIG. 4 described above, the I/O operations may be processed through the storage client rather than a local file system and a storage system. As such, a single task may be concurrently outputted to a plurality of object storage units through the storage client, which can reduce the possibility of disk blocking.

So far, descriptions of the concurrency processing sub-module are completed. According to a conventional data processing way, a plurality of tasks may be distributed to each node for performing, so as to implement the concurrency at a working level. But for each individual task, there is no concurrency in the computing and I/O. When a task has a high requirement on the computing and I/O capacities, the system bottleneck and cluster instability may occur. According to various examples of the present disclosure, the concurrency processing sub-module described above may implement the I/O concurrency processing of the single task, so as to reduce the possibility of the disk blocking.

Hereinafter, the searching sub-module is described in further detail. A data searching process is a data-intensive computing process which costs a large amount of CPU resources. When the amount of data is small, a conventional network device may perform the searching process. When the amount of data is great, it costs very long time to obtain a searching result due to resource constraints. When there is mass data, the conventional network device resources could not meet the processing requirements.

In order to improve the data searching efficiency, according to various examples of the present disclosure, the data searching operation that may be supposed to be performed by the network device is currently performed by the data processing system that is independent of the network device. In this way, the resources outside the network device may be fully used to share the burden of the CPU resources of the network device, so that the resource utilization efficiency of the network device can be improved.

Based on the concurrency processing sub-module 121 as shown in FIG. 4, according to various examples of the present disclosure, the searching sub-module 122 may include a task scheduling management unit 1221 and a feature matching unit 1222 that are deployed in the master node, and a task unit 1223 deployed in each data node, as shown in FIG. 5.

When the data searching is performed, the storage client 1212 on the master node may submit a searching task to the task scheduling management unit 1221. The task scheduling management unit 1221 may receive the searching task and distribute the searching task to more than one task unit 1223. The task unit 1223 may receive the scheduling of the task scheduling management unit 1221 and obtain corresponding feature data from the object storage unit 1214. The feature matching unit 1222 may perform a mapping and reduction operation to the feature data obtained by the task unit 1223 to obtain a final searching result, and return the result to the service logic layer module.

According to various examples of the present disclosure, the feature matching unit 1222 may obtain the final searching result by use of a mapping and reduction mode. The feature matching unit 1222 may include a mapping sub-unit and a reduction sub-unit.

The mapping sub-unit may divide the feature data obtained by each task unit 1223 to obtain a feature data segment, and distribute, according to a load balancing principle, the feature data segment to each task unit 1223 as a mapping task.

The task unit 1223 may read the feature data segment corresponding to the received mapping task and divide the feature data segment into pieces of feature data according to requirements, in which each piece of the feature data is represented in the form of a Key/Value pair. The task unit 1223 may call a customized mapping function to process each Key/Value pair to obtain an intermediate Key/Value pair of each Key/Value pair and output the intermediate Key/Value pair to the reduction sub-unit. In this case, a Key of the feature data is a distance offset of the feature data in the feature data segment read out, and a Value of the feature data is the feature data.

The reduction sub-unit may receive each intermediate Key/Value pair, divide the intermediate Key/Value pairs, combine Values in the intermediate Key/Value pairs sharing a same value of Key to obtain combined Key/Value pairs. The reduction sub-unit may collect and sort the combined Key/Value pairs to obtain the final searching result, and return the result to the service logic layer module.

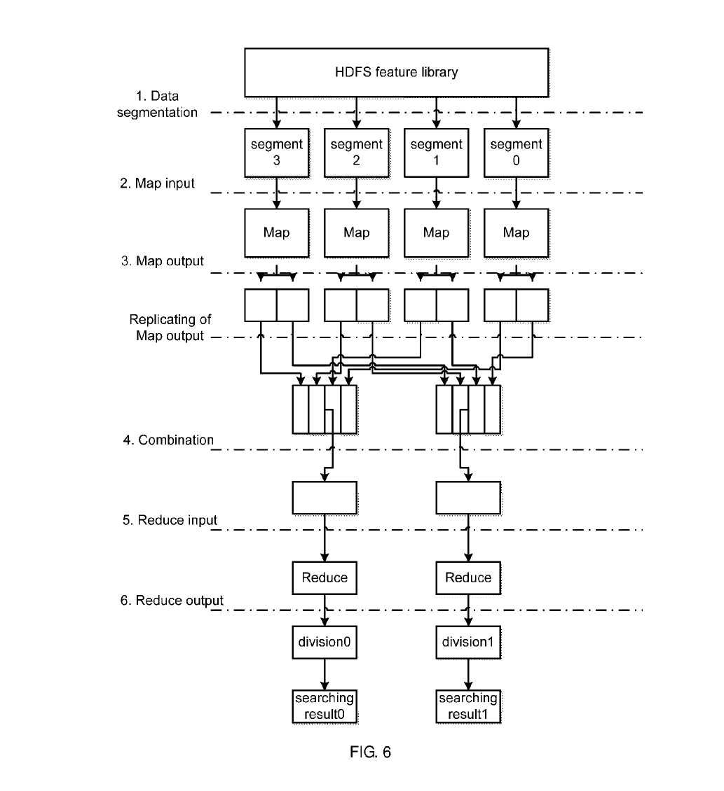

Corresponding to the feature matching unit as shown in FIG. 5, FIG. 6 illustrates a feature matching process, according to various examples of the present disclosure. As shown in FIG. 6, the process may include following operations.

At block 1, data segmentation may be performed. In this case, the feature matching unit may divide the feature data obtained by each task unit from a feature library storage module, such as a Hadoop Distributed File System (HDFS) feature library, to obtain a feature data segment.

At block 2, Map input may be performed. In this case, the feature matching unit may distribute or input, according to a load balancing principle, the feature data segment to each task unit as a mapping task.

At block 3, Map output and replicating of the Map output may be performed. In this case, the task unit may read the feature data segment corresponding to the received mapping task and divide the feature data segment into pieces of feature data according to requirements, in which each piece of the feature data is represented in the form of a Key/Value pair. The task unit may call a customized mapping function to process each Key/Value pair to obtain an intermediate Key/Value pair of each Key/Value pair and replicate the intermediate Key/Value pair, and output the intermediate Key/Value pair to the feature matching unit. In this case, a Key of the feature data is a distance offset of the feature data in the feature data segment read out, and a Value of the feature data is the feature data.

At block 4, combination of the Key/Value pairs may be performed. In this case, the feature matching unit may receive intermediate Key/Value pairs, divide the intermediate Key/Value pairs, combine Values in the intermediate Key/Value pairs sharing a same value of Key to obtain combined Key/Value pairs.

At block 5, Reduce input may be performed. In this case, the feature matching unit may collect and sort the combined Key/Value pairs to obtain the final searching result.

At block 6, Reduce output may be performed. In this case, the feature matching unit may return the final searching result to the service logic layer module.

Based on the above descriptions it may be seen that according to various examples of the present disclosure, the data searching may be implemented using big data cluster processing technology in conjunction with the searching technology in the network device. In this case, through a computing processing framework in a big data cluster system, a searching requirement of an application may be assigned to an “idle” node in the cluster for processing, so as to avoid a real-time issue resulting from high concurrency access and massive data processing and provide a reliable searching service.

So far, descriptions of the feature matching process as shown in FIG. 6 are completed.

The data processing system and method are described above with reference to various examples of the present disclosure. Hereinafter, the data processing system is described in the case of applying the system to the intrusion defense.

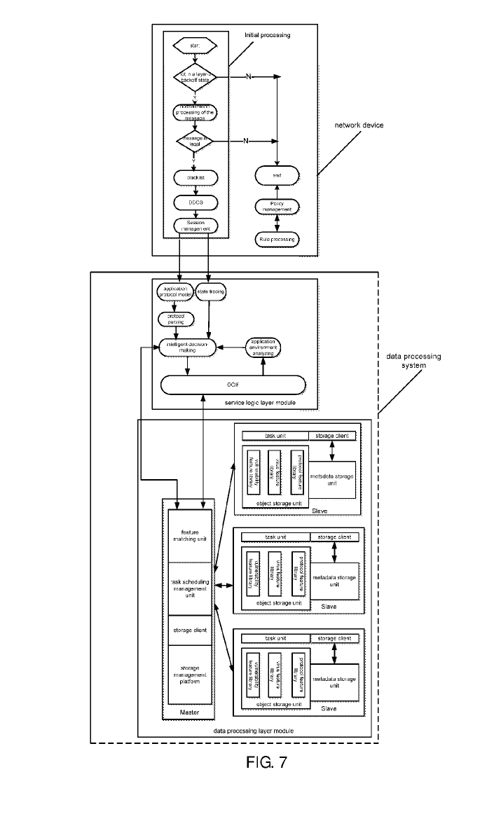

FIG. 7 is a diagram illustrating a structure for implementing the intrusion defense through a network device in conjunction with the data processing system described in various examples of the present disclosure. In the intrusion defense technique, the UAAE and OCIF almost occupy all of CPU resources of the network device when they are running, so that the network device may not have redundant CPU resources to process other operations, which may influence processing of other service processes.

According to various examples of the present disclosure, two operations including the UAAE and OCIF that cost great CPU resources when running are removed from the network device and are performed by the data processing system described in various examples of the present disclosure, as shown in FIG. 7.

As shown in FIG. 7, when the network device receives an application message applied to the intrusion defense, the network device may perform initial processing as shown in FIG. 7, which is not repeated herein.

The network device may send the application message processed with the initial processing to the service logic layer module in the data processing system as shown in FIG. 7.

The service logic layer module may receive the application message processed with the initial processing by the network device, perform application protocol analysis through an established application protocol model to perform the UAAE.

According to various examples of the present disclosure, as shown in FIG. 7, in order to accurately perform the UAAE, the service logic layer module may identify a data feature of the application message and trace the data feature of the application message through a preconfigured feature state machine which has a state so as to accurately perform the UAAE.

At the same time, the service logic layer module may perform intelligent decision-making on the received application message based on a UAAE result.

According to various examples of the present disclosure, one decision result may be that the service logic layer module may directly perform the OCIF to the application message and send the application message performed with the OCIF to the data processing layer module.

According to various examples of the present disclosure, another decision result may be that the service logic layer module may directly send the application message to the data processing layer module.

When the data processing layer module in the data processing system as shown in FIG. 7 receives the application message sent from the service logic layer module, the data processing layer module may perform searching and/or single task I/O concurrency processing to the application message.

When the searching is performed by the data processing layer module to the application message, a storage client on a master node as shown in FIG. 7 may submit a searching task to a task scheduling management unit. The task scheduling management unit may receive the searching task and distribute the searching task to more than one task unit. The task unit may receive the scheduling of the task scheduling management unit and obtain corresponding feature data from an object storage unit on a data node where the task unit is located. A feature matching unit may perform a mapping and reduction operation to the feature data obtained by the task unit to obtain a final searching result. When the data processing layer module completes the searching, the data processing layer module may return the final searching result to the service logic layer module.

When the single task I/O concurrency processing is performed by the data processing layer module to the application message, the storage client on the master node as shown in FIG. 7 may interact with a storage management platform to determine an object corresponding to file data to be performed with the I/O concurrency processing, and send the determined object to a storage client storing the object on a data node. The storage client on the data node may interact with an object storage unit on the data node to implement the I/O concurrency processing. In this case, the object storage unit on the data node may store data taking an object as an unit. The file data corresponding to the object may be stored in a metadata storage unit associated with the object storage unit. When the data processing layer module completes the single task I/O concurrency processing, the data processing layer module may return a result to the service logic layer module.

When the service logic layer module receives the result returned from the data processing layer module, the service logic layer module may directly perform the intelligent decision-making to the returned result according to a first way. Alternatively, according to a second way, the service logic layer module may perform the OCIF to the returned result to obtain an intermediate result and perform the intelligent decision-making to the intermediate result.

According to various examples of the present disclosure, when the service logic layer module performs the intelligent decision-making to the returned result or to the intermediate result, the service logic layer module may perform the intelligent decision-making considering analysis of a current application environment. When the service logic layer module determines an operation to be performed by the network device, the service logic layer module may notify the network device to perform the operation. When the service logic layer module determines an operation to be performed by the data processing layer module, the service logic layer module may notify the data processing layer module to perform the operation.

So far, descriptions of FIG. 7 are completed.

The above-mentioned modules or units in the examples of the present disclosure may be deployed either in a centralized or a distributed configuration, and may be either merged into a single module or unit, or further split into a plurality of sub-modules or sub-units.

These modules or units may be implemented by hardware, such as a general purpose processor, in combination with machine readable instructions stored in a computer readable medium and executable by the processor, or by dedicated hardware (e.g., the processor of an Application Specific Integrated Circuit (ASIC)), Field Programmable Gate Array (FPGA) or a combination thereof.

As may be seen from the above descriptions that according to various examples of the present disclosure, the service logic layer module can model a wide variety of application protocols, identify classification of the application protocols, and perform the intelligent decision-making based on the model identification, which can improve the data processing accuracy.

According to various examples of the present disclosure, the storage client, file system management modules (such as the storage management platform), and each object storage unit may be connected by the hard links instead of conventional HTTP transmission and the file system may be accessed through the storage client, which can reduce the network storm, distribute the network traffic, and reduce the possibility of the network bottleneck.

In addition, according to various examples of the present disclosure, the access of the file system may be processed through the storage client in the data processing layer module (including the storage client on the master node and the storage client on the data node), instead of a local operating system and an original storage system of the network device. In this way, a plurality of computing tasks may be concurrently outputted to the object storage units on a plurality of data nodes, which can reduce the possibility of disk blocking.

According to various examples of the present disclosure, the data searching that may be supposed to be performed by the network device is performed by the data processing system that is independent of the network device. In this way, the resources outside the network device may be fully used to share the burden of the CPU resources of the network device, so that the resource utilization efficiency of the network device can be improved.

The above examples may be implemented by hardware, software or firmware, or a combination thereof. For example, the various methods, processes and functional modules described herein may be implemented by a processor (the term processor is to be interpreted broadly to include a CPU, processing unit, ASIC, logic unit, or programmable gate array, etc.). The processes, methods, and functional modules disclosed herein may all be performed by a single processor or split between several processors. In addition, reference in this disclosure or the claims to a ‘processor’ should thus be interpreted to mean ‘one or more processors’. The processes, methods and functional modules disclosed herein may be implemented as machine readable instructions executable by one or more processors, hardware logic circuitry of the one or more processors or a combination thereof. Further the examples disclosed herein may be implemented in the form of a computer software product. The computer software product may be stored in a non-transitory storage medium and may include a plurality of instructions for making a computer apparatus (which may be a personal computer, a server or a network apparatus such as a router, switch, access point, etc.) implement the method recited in the examples of the present disclosure.

All or part of the procedures of the methods of the above examples may be implemented by hardware modules following machine readable instructions. The machine readable instructions may be stored in a computer readable storage medium. When running, the machine readable instructions may provide the procedures of the method examples. The storage medium may be diskette, CD, ROM (Read-Only Memory) or RAM (Random Access Memory), and etc.

The figures are only illustrations of examples, in which the modules or procedures shown in the figures may not be necessarily essential for implementing the present disclosure. The modules in the aforesaid examples may be combined into one module or further divided into a plurality of sub-modules.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims and their equivalents in which all terms are meant in their broadest reasonable sense unless otherwise indicated.

What is claimed is:

1. A data processing system, comprising:
a service logic layer module, to
receive an application message forwarded by a network device, classify and identify an application type of the application message, and determine a first processing operation to be performed to the application message based on an identification result; and
receive a processing result returned from a data processing layer module, and determine a second processing operation based on the processing result; and
the data processing layer module comprising a concurrency processing sub-module and a searching sub-module;
wherein when the processing operation determined by the service logic layer module is an I/O processing operation for a single task, the concurrency processing sub-module is to control I/O concurrency processing of the single task and return a final processing result to the service logic layer module after the I/O concurrency processing of the single task is performed; and
when the processing operation determined by the service logic layer module is a data searching operation, the searching sub-module is to perform the data searching operation to obtain a final searching result, and return the final searching result to the service logic layer module.

2. The system of claim 1, wherein the application message is forwarded by the network device when processing of the application message meets a defined condition;
wherein the defined condition comprises a condition that central processing unit (CPU) resources of the network device occupied by the processing of the application message is greater than a defined threshold.

3. The system of claim 1, wherein the service logic layer module is further to:
classify and identify the application type of the application message using an application protocol model established for an application protocol in advance,
and/or,
identify a data feature of the application message, and trace the data feature of the application message through a preconfigured feature state machine which has a state to accurately identify the application type of the application message.

4. The system of claim 1, wherein the data processing layer module is constructed by a master node and a data node;
wherein the concurrency processing sub-module comprises a storage management platform and a storage client that are deployed in the master node, and a storage client and an object storage unit that are deployed in the data node;
wherein
the storage management platform is to manage a file system;
the storage client in the master node is to interact with the storage management platform, and determine an object corresponding to file data to be performed with the I/O concurrency processing of the single task;
the storage client in the data node is to provide access to the file system, and interact with the object storage unit to implement the I/O concurrency processing; and
the object storage unit is to store data taking an object as a basic unit; wherein the file data corresponding to the object is stored in a metadata storage unit associated with the object storage unit;
wherein the searching sub-module comprises a task scheduling management unit and a feature matching unit that are deployed in the master node, and a task unit deployed in the data node;
wherein
when the data searching operation is performed, the storage client in the master node is to submit a searching task to the task scheduling management unit;
the task scheduling management unit is to receive the searching task and distribute the searching task to the task unit;
the task unit is to receive scheduling of the task scheduling management unit and obtain feature data from the object storage unit; and
the feature matching unit is to perform a mapping and reduction operation to the feature data obtained by the task unit to obtain the final searching result, and return the final searching result to the service logic layer module.

5. The system of claim 4, wherein the master node and the data node are connected through a hard link, and data nodes are connected through the hard link;
wherein connecting the master node and the data node through the hard link comprises a situation that the master node and the data node directly communicate with each other without forwarding of a third party device, and connecting the data nodes through the hard link comprises a situation that the data nodes directly communicate with each other without forwarding of the third party device.

6. The system of claim 4, wherein the feature matching unit comprises a mapping sub-unit and a reduction sub-unit; wherein
the mapping sub-unit is to
divide the feature data obtained by the task unit to obtain a feature data segment, and
distribute, according to a load balancing principle, the feature data segment to the task unit as a mapping task;
the task unit is to
read the feature data segment corresponding to the received mapping task, divide the feature data segment into pieces of feature data according to requirements, wherein each piece of the feature data is represented in the form of a Key/Value pair, and
call a customized mapping function to process each Key/Value pair to obtain an intermediate Key/Value pair of each Key/Value pair and output the intermediate Key/Value pair to the reduction sub-unit; wherein a Key of the feature data is a distance offset of the feature data in the feature data segment read out, and a Value of the feature data is the feature data;
the reduction sub-unit is to
receive intermediate Key/Value pairs and divide the intermediate Key/Value pairs,
combine Values in the intermediate Key/Value pairs sharing a same value of the Key to obtain combined Key/Value pairs,
collect and sort the combined Key/Value pairs to obtain the final searching result, and
return the final searching result to the service logic layer module.

7. A data processing method comprising:
receiving, by a service logic layer module of the data processing system, an application message forwarded by a network device, classifying and identifying an application type of the application message, and determining a processing operation to be performed to the application message based on an identification result;
when the processing operation determined by the service logic layer module is an I/O processing operation for a single task, controlling, by a concurrency processing sub-module of a data processing layer module of the data processing system, I/O concurrency processing of the single task and returning a final processing result to the service logic layer module after the I/O concurrency processing of the single task is performed;
when the processing operation determined by the service logic layer module is a data searching operation, performing, by a searching sub-module of the data processing layer module, the data searching operation to obtain a final searching result, and returning the final searching result to the service logic layer module; and
receiving, by the service logic layer module, a processing result returned from the data processing layer module, and determining a second processing operation based on the processing result.

8. The method of claim 7, wherein the application message is forwarded by the network device when processing of the application message meets a defined condition;
wherein the defined condition comprises a condition that central processing unit (CPU) resources of the network device occupied by the processing of the application message is greater than a defined threshold.

9. The method of claim 7, wherein the operation of classifying and identifying the application type of the application message by the service logic layer module comprises:
classifying and identifying, by the service logic layer module, the application type of the application message using an application protocol model established for an application protocol in advance,
and/or,
identifying, by the service logic layer module, a data feature of the application message, and tracing the data feature of the application message through a preconfigured feature state machine which has a state to accurately identify the application type of the application message.

10. The method of claim 7, wherein the data processing layer module is constructed by a master node and a data node;
wherein the concurrency processing sub-module comprises a storage management platform and a storage client that are deployed in the master node, and a storage client and an object storage unit that are deployed in the data node; and
the operation of controlling, by the concurrency processing sub-module, the I/O concurrency processing of the single task comprises:
interacting, by the storage client in the master node, with the storage management platform to determine an object corresponding to file data to be performed with the I/O concurrency processing, and sending the determined object to the storage client in the data node storing the object; and
interacting, by the storage client in the data node, with the object storage unit to implement the I/O concurrency processing;
wherein the object storage unit is to store data taking an object as a basic unit, and the file data corresponding to the object is stored in a metadata storage unit associated with the object storage unit;
wherein the searching sub-module comprises a task scheduling management unit and a feature matching unit that are deployed in the master node, and a task unit deployed in the data node; and
the operation of performing, by the searching sub-module, the data searching operation comprises:
when the data searching operation is performed, submitting, by the storage client in the master node, a searching task to the task scheduling management unit;
receiving, by the task scheduling management unit, the searching task and distributing the searching task to the task unit;
receiving, by the task unit, scheduling of the task scheduling management unit and obtaining feature data from the object storage unit; and
performing, by the feature matching unit, a mapping and reduction operation to the feature data obtained by the task unit to obtain the final searching result, and returning the final searching result to the service logic layer module.

11. The method of claim 10, further comprising:
connecting the master node and the data node through a hard link and connecting data nodes through the hard link;
wherein the connecting the master node and the data node through the hard link comprises a situation that the master node and the data node directly communicate with each other without forwarding of a third party device, and the connecting the data nodes through the hard link comprises a situation that the data nodes directly communicate with each other without forwarding of the third party device.

12. The method of claim 10, wherein the operation of performing, by the feature matching unit, the mapping and reduction operation to the feature data obtained by the task unit to obtain the final searching result and returning the final searching result to the service logic layer module comprises:
dividing the feature data obtained by the task unit to obtain a feature data segment;
distributing, according to a load balancing principle, the feature data segment to the task unit as a mapping task, so that the task unit reads the feature data segment corresponding to the received mapping task, divides the feature data segment into pieces of feature data according to requirements, wherein each piece of the feature data is represented in the form of a Key/Value pair, and calls a customized mapping function to process each Key/Value pair to obtain an intermediate Key/Value pair of each Key/Value pair and outputs the intermediate Key/Value pair to the feature matching unit; wherein a Key of the feature data is a distance offset of the feature data in the feature data segment read out, and a Value of the feature data is the feature data;
receiving intermediate Key/Value pairs and dividing the intermediate Key/Value pairs;
combining Values in the intermediate Key/Value pairs sharing a same value of the Key to obtain combined Key/Value pairs;
collecting and sorting the combined Key/Value pairs to obtain the final searching result, and
returning the final searching result to the service logic layer module.
